(19) United States
(12) Patent Application Publication
(10) Pub. No.: US 2013/0311591 A1
(43) Pub. Date: Nov. 21, 2013

(54) COMPUTER SYSTEM FOR THE EXCHANGE OF MESSAGES

(71) Applicants: Alexander Zacke, Vienna (AT); Georg Untersalmberger, Rekawinkel (AT)

(72) Inventors: Alexander Zacke, Vienna (AT); Georg Untersalmberger, Rekawinkel (AT)

(73) Assignee: ISA AUCTIONATA AUKTIONEN AG, Vienna (AT)

(21) Appl. No.: 13/983,680

(22) PCT Filed: May 24, 2011
(86) PCT No.: PCT/EP2011/058453

§ 371 Date: Aug. 5, 2013

(51) Int. Cl. H04L 12/58

(52) U.S. Cl. CPC H04L 51/00
USPC 709/206

(57) ABSTRACT

A computer system for the exchange of messages via the Internet for the online processing of trade transactions has a plurality of client computers with Internet interfaces, at least one central lead-server connected to a central data base, and distribution points with a filter function arranged between client computers and the lead-server. A plurality of proxy computers act as distribution points between the client computers and the central lead-server. The proxy computers have at least one load balancer module adapted to distribute messages among the predefined proxy computers arranged upstream of them. Hach proxy computer comprises a relevance filter module which is adapted to check arriving messages coming in from client computers for their relevance according to predefined criteria and to forward only relevant messages. The communication between client computers and proxy computers is based on the HTTP protocol.

### FIELD OF INVENTION

The invention relates to a computer system for the exchange of messages via the internet for the online processing of trade transactions, comprising a plurality of client computers with internet interfaces, at least one central lead-server connected to a central data base, and distribution points with a filter function arranged between client computers and the at least one lead-server, according to the preamble of claim 1.

### BACKGROUND OF THE INVENTION

A computer system of this kind with a filter function is known from the US 2007/0214074 A1, for example; a somewhat different system with data filtering is described in the US 2009/0063360 A1.

With the computer system described in the US 2007/0214074 A1 respective groups of client computers are connected via a network, for example the internet, with fixedly assigned distribution points, wherein, however, the number of client computers provided per distribution point is limited (to max. 200). This means, on the other hand, that for a large number of client computers a disproportionately high number of distribution points is required. Furthermore, the distribution points must be implemented so as to be fault-tolerant, which means additional expenditure. In addition a special software has to be installed on the client computers in order to participate in the system, which means additional expenditure on the one hand, whilst on the other hand, it is not always possible to install such a special software on the computers.

It is an aim of the invention to provide a real-time online computer system for the exchange of messages for processing trading processes with a technically unlimited number of participants based on the available technologies of the world-wide-web (www, “web” for short) and taking its limitations into consideration. In particular a system shall be provided which makes it possible, at little expense, to transfer trade flows (including those in the auction trade) along with its associated messages between the participants involved in the trade over the internet in real time and to make them visible via a web interface. This means that messages from users of the system, i.e. from buyers, sellers and auctioneers, are to be transferred immediately to those users of the system for whom these messages are relevant. At this moment in time “immediately” is understood to mean a period of 1 second. On the terminal side, the system shall require only one modern web browser and it shall not be necessary to install any further software on the users' terminals.

The system shall be suitable for holding very large trade events with more than a million of simultaneously present users and several (virtual) trading spaces between which the users can alternate ad lib. This means that on the one hand, a very large number of users shall be able to send messages, and that on the other hand, these messages shall, as quickly as possible, be made visible to all users concerned (for example acceptance of a bid by the seller or auctioneer).

For better understanding of the explanations below we should like to first define a number of terms:

Trading process: a process between two or more trading partners who conclude trade transactions through the submission and acceptance of offers.

Message: a message is an information unit which is transmitted from a sender to one or several recipients. In the present system, messages are understood to be text messages of any kind, but they can also be offers on articles, acceptances of offers as well as other trade and/or user actions, each of which require to be transferred to a trading partner.

Message block: this is a group of related messages, for example offers concerning a traded article.

Latency: Latency is the period between a sender placing an offer/sending a message and making it visible at the recipient.

Real time: “Real time” is understood here as being the behaviour of a system which has an average latency of less than 1 second.

Web interface: a web interface is the user interface of a program which can be made visible using only means of the world wide web and only within a web browser, and which can only be operated using means of the world wide web and those of a web browser.

User: A participant in a trading process connected to the system via the internet or via a web browser.

The requirements mentioned in the beginning which the proposed computer system has to meet, mean that in summary the computer system, from a technical point of view, has to satisfy the following conditions:

Real time behaviour throughout the internet without installation of a software, i.e. only one (modern) web browser shall be necessary, which shall be instrumental in achieving the highest possible accessibility and distribution.

Unlimited scalability for unchanged latency, i.e. for an increasing number of users—assuming that user activity per user remains constant—latency shall also remain constant.

Unlimited real time behaviour shall be possible even for the smallest of bandwidths, for example for modem connections or connections via narrow-band mobile terminal connections such as GPRS (i.e. bandwidths within a range of 40 Kbits/s downlink and 10 Kbits/s uplink).

Compatibility with firewall, router and proxy technologies, as commonly used in the internet, and in particular with the IPv4 internet protocol which de facto is still exclusively used in the internet is a pre-condition.

Software installations on client computers are, as a rule, not possible, not desired or not permitted or require too much computer knowledge and too much time. This also applies to web browser plug-ins. The necessary client functionality must therefore be able to be implemented using the functions which a modern web browser has already built-in. These are as follows:
display of HTML or XHTML together with CSS
DOM (W3C: Document Object Model) (DOM),
http://www.w3.org/DOM/) and access via JavaScript
Use of the XMLHttpRequest object (W3C: XMLHttpRequest XMLHttpRequest, W3C working draft, http://www.w3.org/TR/XMLHttpRequest)

Applicable formats for data transfer are XML and JSON (JavaScript Object Notation)(Network Working Group: JavaScript Object Notation, RFC 4627, http://www.ietf.org/rfc/rfc4627.txt); these formats are available via the JavaScript functions of the web browsers. This combination of functions is also known as AJAX (Asynchronous JavaScript and XML).

As regards firewalls and routers it is by no means certain that these will allow HTTP requests other than regular HTTP requests to pass. Even tunnelling of other protocols through HTTP tunnelling (http://en.wikipedia.org/wiki/HTTP_tunnel) may be blocked by transfer facilities for safety reasons; methods of this nature are therefore not possible.

Since it is not possible to transfer the messages actively and directly in the form of a notification from the server to the client using the HTTP protocol, a client keeps querying:

In order to make direct notifications of user actions visible at the client this client calls up status information from the server automatically, at very brief intervals (approx. 1 second) (so-called “polling”). This is done utilising AJAX technology which is generally available in modern browsers. However this polling, without further measures, leads to a very high load on the server since all connected clients send requests not just when user actions occur on the web interface, but continuously. This high number of requests must be distributed accordingly among a large number of servers, since a single server will, at some time, be no longer sufficient for the growing number of users. A very large number of users will then require a large number of servers.

But if more than one server receives messages from users, then not all servers will receive these messages sent by one user to a single server, until a link (a so-called backbone) is simultaneously set up between the servers via which all messages are forwarded immediately by the receiving server to all other servers. This means a squared increase in system load for the backbone so that scalability of the system comes to an end very quickly. The increase in system load is squared because, assuming a constant number of messages per unit of time for each user, if all messages are forwarded to all users, the number of receiving users increases linearly with the growing number of sending users.

If a very large number of servers are operated in parallel a central entity (for example a data base) must be created which supplies the servers with all current, i.e. new or amended, messages. If all messages from all users are forwarded to the central entity the increase in the load on this entity is also squared. The way in which this is usually done is to enquire for messages at the central entity and then to store them in a cache on the servers so that these do not need to access the central entity each time a client is polling. In order to then achieve a significant reduction in backbone network traffic the caching interval would need to be very long; but this means that immediate transfer of messages (in real time) is no longer possible.

In summary therefore, it is the technical requirement of the invention to design a computer system of the kind mentioned in the beginning in such a way that even for the indicated large number of users and the use of traditional web browsers, the messages required for respective trade transactions can be transferred and made visible practically in real time with even small bandwidths being admissible, if required.

### DESCRIPTION OF THE INVENTION

This requirement is met by the computer system according to the invention, which may be defined as follows:

A plurality of proxy computers is provided to act as distribution points between the client computers and the at least one central lead-server, which proxy computers have at least one load balancer module adapted to distribute messages among the predefined proxy computers arranged upstream of them and which each comprise a relevance filter module which is adapted to check arriving messages coming in from client computers for their relevance according to predefined criteria and to forward only relevant messages, and in that the communication between client computers and proxy computers is based on the HTTP protocol, as defined in claim 1 of the invention.

Advantageous embodiments and further developments are defined in the dependent claims.

With the computer system according to the invention proxy computers (also called interlink or interconnected computers) are arranged as distribution points between client computers (called “clients” for short in the following) and the at least one central lead-server; these proxy computers (called “proxy” for short in the following) have “load distribution modules” (experts call them “load balancer” modules or computers) allocated to them for distributing messages arriving from clients among respective proxy computers; each proxy computer includes a relevance filter module which assesses the messages arriving from clients for their relevance according to predefined criteria and forwards only messages determined as being relevant, or passes them on for further processing. The extent to which messages are relevant depends on the respective transactions and this is determined accordingly as will be explained in detail below.

In the present computer system a two-step optimisation of the message flow from client to server and back is provided with regard to user actions. Each step of this optimisation process may utilise especially optimised data reduction methods and filtering methods which are based on the asymmetric message flow typical in present systems.

Another important point of the present computer system is that user functions are available only via the world wide web. All applications (websites) establish the connection from a client (client computer) to a server (server computer) or, as here, to a proxy computer via the HTTP protocol (W3C: Hypertext Transfer Protocol—HTTP/1.1, RFC 2616, http://www.w3.org/protocols/rfc2616/rfc2616.html), so that these can be used via a web browser. The HTTP protocol is based on a simple request/response model (W3C: Hypertext Transfer Protocol—HTTP/1.1, RFC 2616, Overall Operation, section 1.4, http://www.w3.org/protocols/rfc2616/rfc2616-secl.html#secl.4), where a client always queries information from a server; direct message transfer from client to client is not provided for in the web. If a client wants to send a message to another client, it has to send it initially to a server by means of an HTTP request, the other client or clients then receive this message upon request at the server via an HTTP request.

Further the HTTP protocol does not permit any direct notification of clients through a server—in this case a proxy server—with regard to the fact that a message is present and ready on the server. Thus any messages sent, even if they have already been transferred to the server, will not immediately become visible (to users) on client computers. A client must always actively enquire. As a rule this requires a user action and a request to the server triggered by the user action, usually involving a considerably delay.

The proxy computers may also be configured in cascade form, i.e. it is of advantage to arrange at least one proxy computer in cascade with proxy computers arranged upstream. With such a configuration the proxy computer arranged downstream in the cascade conveniently comprises a relevance filter module in order to only forward relevant messages arriving from upstream proxy computers.

Preferably the central lead-server or lead-computer also comprises a relevance filter module such that only relevant messages arriving from proxy computers are acquired through filtering and passed on for further processing.

Further the central lead-server may comprise a local data base or may be connected to a local data base in order to at least temporarily store messages recognised as not being relevant. In a corresponding manner it is advantageous with the present computer system if at least one of the proxy computers has a local data base allocated to it for at least temporarily storing messages recognised as not being relevant. In consequence it is then also advantageous if a system load checking unit is provided which is configured to arrange for the transfer of non-relevant messages stored in one or several local data bases to the central data base, for data consolidation at times when the load on the computer system is reduced.

As already known clients may further be adapted to cyclically request messages destined for them from the associated proxies at predetermined intervals (so-called polling). On the other hand it is convenient if clients are adapted to transfer messages to the respective proxies directly, outside the predetermined polling intervals, that is “out of band”. Accordingly new incoming messages generated on a client are always initially sent to a proxy by means of an out-of-band polling request. The proxy then decides on the basis of the filtering result whether this message should be forwarded immediately to the lead-server or the next proxy in the cascade, or whether it should be initially stored locally, in the local data base, and not forwarded until at a later stage for data consolidation.

In order to reduce bandwidth the respectively transferred messages in the present computer system are advantageously provided with a time stamp, and as a result of such a timestamp-based data reduction process only amended or new messages are transferred from the lead-server to the clients as part of the polling response.

The lead-server stores all messages in the allocated central data base from where the data can be read again by the lead-server and, as required, also by further lead-servers operated in parallel in order to increase failure safety.

The lead-server in turn decides on the basis of a filter algorithm specified in the filter module, which messages shall be transferred to all proxies. And only these messages will be immediately stored in the central data base. Transfer to the proxies takes place upon active notification of the proxies by the lead-server. These active notifications either contain information on the amended or new messages, or the proxies, after having received the notification, query the lead-server for new or amended messages.

Even if there are no new or amended messages on the lead-server, the lead-server conveniently continuously emits a “heartbeat”. From the absence of this heartbeat the proxies can draw the conclusion that the lead-server has failed and they can then query another server entity operated in parallel for new messages, which entity can then, as queries arrive from a proxy, read the current messages from the central data base.

Filtering is determined according to the requirements of the corresponding trading processes resulting in the transfer to the lead-server of only those messages necessary for the trading process or in notifying the proxies of only those messages. This means that only a small number of (incoming) messages is transferred to the lead-server, thereby considerably lightening the load on the transferring network and the components involved. Filtering is constituted, for example, by the fact that no offers are transferred which have already been superseded by a higher offer from another bidder on the proxy or the lead-server.

Clients poll a proxy for the presence of new messages, for example new offers. This polling takes place through repeatedly sending polling requests from the respective client to the proxy. The polling requests are repeated at regular time intervals, called polling intervals. The respective proxy responds, as necessary, with information on new or amended messages which will be displayed on the client.

Polling requests are conveniently performed via AJAX, i.e. through using the XML-HTTP request object on the client side. AJAX is preferably used in order to avoid having to call up a complete page view of the web browser for each query. Such a page view would lead to a new positioning of the display of the website (the page scrolls right to the top) and in addition would cause the page not being displayed at all or only incompletely for a certain period of time which is noticeable to the user. Moreover this would use up unnecessary resources on the client.

A polling response could include information on more than one message from more than one message block. In the response an object structure is handed over via XML or JSON by means of which the web browser can recognise which objects (message blocks, individual messages) have to be updated in the display. The web browser then performs this update by means of JavaScript and DOM.

For example, the page might display a list of the latest offers received for buying an article: this list for example carries the “Offers” ID (ID: s. W3C: HTML 4.01 Specification, element identifiers: the id and class attributes, http://www.w3.org/TR/htm1401/struct/global.html#h-7.5.2). In the polling response a (logical) data structure is then handed over.

A proxy, for its part, obtains current or amended messages from the lead-server or from a further interposed cascaded proxy. However, a proxy does not have to continually query the lead-server whether new or amended messages are present, rather it is actively notified by the lead-server, if this is the case.

### SHORT DESCRIPTION OF THE DRAWINGS

The invention will now be described in detail by way of preferred embodiments to which, however, it is not limited, and with reference to the attached drawing, in which

FIG. 1 schematically shows, in a block diagram, a computer system according to one embodiment of the invention for which the online-processing of trade transactions is suitable;

FIG. 2 schematically shows, in a block diagram, in more detail, an interlink computer provided in the computer system of FIG. 1, here called a proxy computer;

FIG. 3 schematically shows, in a block diagram, a proxy computer in communication with a central lead-server, also called lead-computer or controller, wherein the proxy computer has a client computer arranged upstream of it;

FIGS. 4, 5 and 6 show schematic flow diagrams for illustrating the operations when sending polling requests and returning messages (FIG. 4), furthermore when sending polling requests and returning responses with the provision of time stamps (FIG. 5) and when sending polling requests and “out-of-band” requests” (FIG. 6);

FIGS. 5A and 5B show HTTP polling protocols in the case of a request (see FIG. 5A), and for a response (see FIG. 5B);

FIG. 7 shows, in a flow diagram, the process of a polling request;

FIGS. 8 and 9 show flow diagrams for filter operations on a proxy computer (FIG. 8) on the one hand, and on a lead-server (FIG. 9) on the other;

FIG. 10, in a flow diagram, shows the process of a notification of a proxy computer;

FIG. 11, in a schematic diagram, shows the arrangement or the operation during data consolidation, when data is transferred from local data bases to the central data base;

FIG. 12 shows a schematic flow (flow diagram) pertaining to data consolidation;

FIGS. 13A, 13B and 13C, in a sequence diagram (FIG. 13A) and in flow diagrams relating to filter operations on the proxy computer (FIG. 13B) and on the lead-server (FIG. 13C), show the application of the present computer system for the sale of individual articles;

FIGS. 14A (sequence diagram), 14B (filtering on a proxy) and 14C (filtering on a server) show an example for using the present computer system for a live online trade;

FIGS. 15A to 15C, in respective sequence and filtering flow diagrams, show the operation for the online sale of quantities of an article (so-called “teleshopping channel”);

FIGS. 16A, 16B and 16C, again in respective diagrams (overview or filtering on a proxy or lead-server), show the approach for a so-called “English bidding method”; and

FIGS. 17A, 17B and 17C, in respective diagrams, show the approach for a so-called “Dutch bidding method”.

### DETAILED DESCRIPTION OF PREFERRED EMBODIMENTS

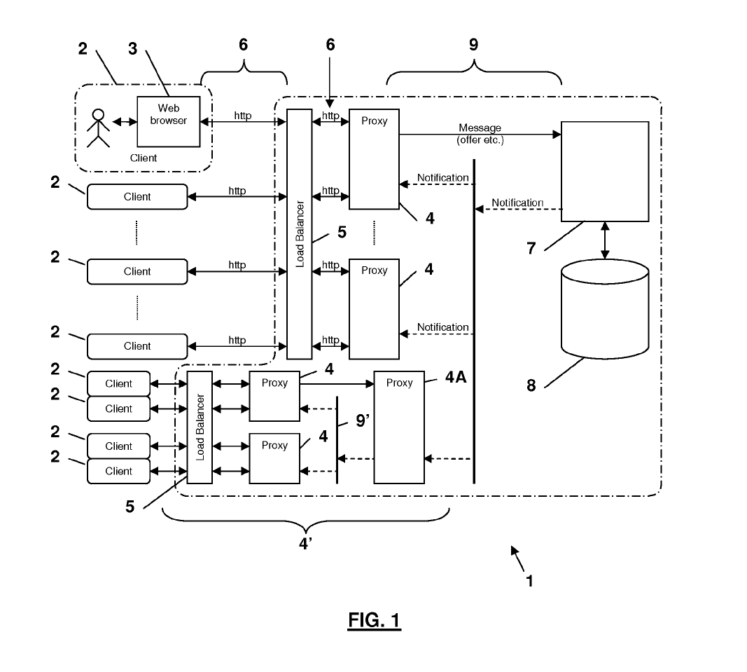

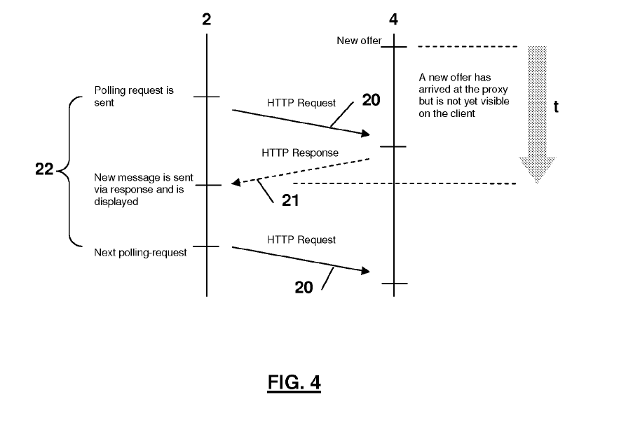

FIG. 1 shows a computer system 1 for exchanging messages via the internet, for the online processing of trade transactions or trading processes, wherein a plurality of client computers 2 respectively equipped with a web browser 3 as shown in FIG. 1 for uppermost client computer 2, are connected via the internet with interlink computers or interconnected computers, normally called proxy computers or proxy 4, for short. This includes the possibility of a cascaded proxy configuration as illustrated in FIG. 1 with two lower proxies 4 and cascaded proxy computer 4A arranged downstream, in order to achieve an additional distribution of tasks. The proxy computers 4 have load distribution modules arranged upstream of them, which are usually called load balancer modules, load balancer computers or “load balancers” 5 for short. Between client computers 2 and proxy computers 4, or associated load balancer modules 5, respectively, messages are communicated via internet 6 in accordance with the HTTP protocol, as indicated by the “http” double arrows in FIG. 1. With this arrangement use is made of the so-called polling principle as illustrated in FIGS. 4 to 7 described below. Furthermore, computer system 1 provides for the use of a lead-server 7 or lead-computer, also called controller, wherein this lead-server 7 has a central data base 8 assigned to it. Several instances of this central entity 7(8) may be provided, in order to ensure nevertheless, in case of a malfunction, the functioning of computer system 1 as a whole, should a lead-server 7 fail.

In general computer system 1 is configured in such a way that a plurality of clients 2 are provided per proxy 4, for example 10,000 clients per proxy 4. On the other hand numerous proxy computers 4, for example 10,000 proxy computers 4, are assigned to the lead-server 7; this means that client computers 2 and thus users in their millions can subscribe to the system, in order to perform trading processes, no matter in which form, as will be described below in more detail.

FIG. 1 also schematically shows a so-called backbone link 9 between proxy computers 4, 4A and lead-server 7, wherein a respective backbone link 9′ is provided in the area of the cascaded proxy configuration 4′. Via these backbone links 9, 9′ respective notifications are forwarded from the respective higher location, for example the lead-server 7, to the next lower locations, i.e. proxy computers 4 or cascade proxy computer 4A, following filtering in the respective proxy computer 4 or 4A, as will be explained below.

In the present computer system 1 proxy computers 4 are instrumental in substantially relieving the load on the central lead-server 7; in other words, only through this thus created division of work with the associated two-step optimisation of the message flow between client computers 2 and lead-server 7, is it possible, in conjunction with other functions still to be explained in more detail, to ensure the desired processing of trading processes in real time (i.e. within time periods of 1 second maximum) for a plurality of users (clients 2), for example millions of them.

One essential function which is implemented in proxy computers 4 or 4A, but also in the lead-server 7, is the already discussed filtering function, in order to check incoming messages for their relevance and to forward or process only relevant messages.

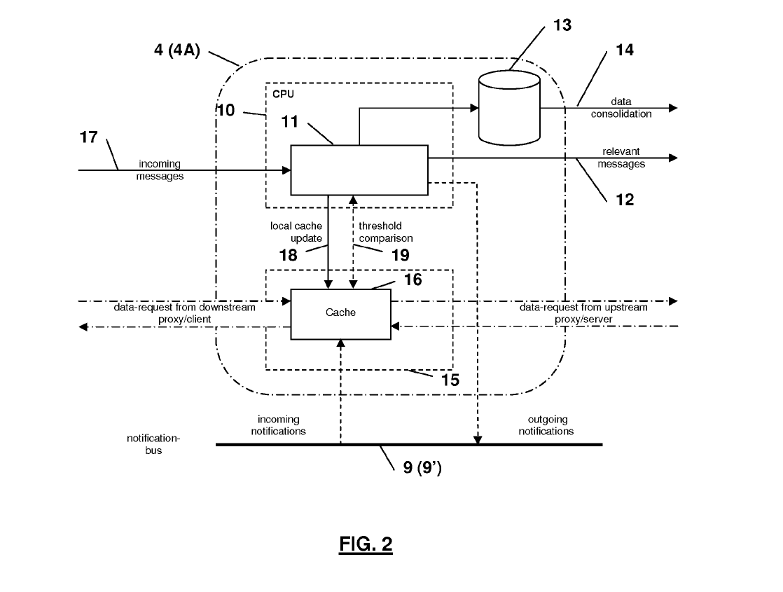

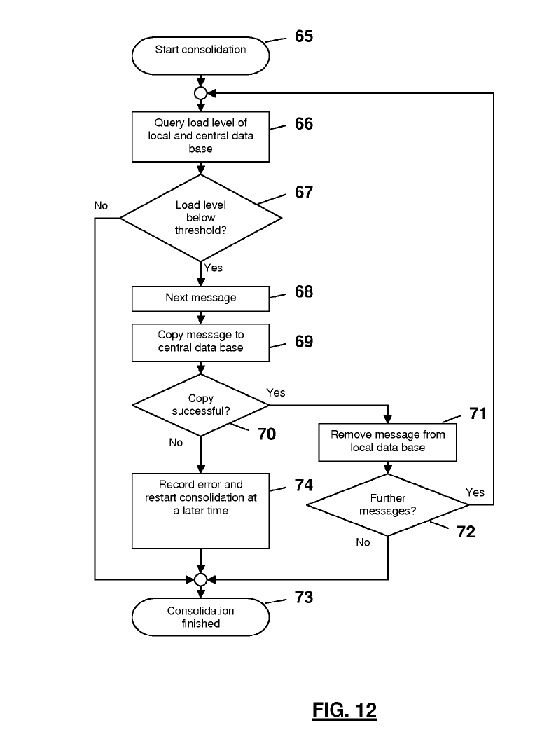

FIG. 2 schematically shows the general structure of a proxy computer 4 or 4A, wherein in the area of a CPU 10 a relevance filter module 11 has been realised which performs filtering of incoming messages for their relevance. The messages obtained as relevant through the filtering process are forwarded via a link 12 to the next higher location, for example to lead-server 7 (FIG. 1) or to the cascaded proxy computer 4A; messages filtered out because they are not relevant are stored in a local data base 13 of proxy computer 4 or 4A (which, of course, may be a separate data base with which proxy computer 4 or 4A is connected); as part of a data consolidation which will be explained in detail below with reference to FIGS. 11 and 12, data are passed on, at times when the load on computer system 1 is less, via a link 14 to the central location or central data base 8.

Proxy computer 4 or 4A also includes a working memory 15 in which a cache 16 is realised, and in which local messages arriving via a link 17 for example from a client computer 2 (or from a preceding proxy computer 4) are stored as part of an update, see also link 18 in FIG. 2; the stored updates are utilised via link 19 for a comparison during relevance filtering, as will be explained in more detail below. In FIG. 2 furthermore chain-dotted lines depict, for the connection to a client computer 2 as well as to the lead-computer 7 or in case a cascade configuration of proxy computers (4′ or 4, 4A in FIG. 1), a data enquiry from a client 2 or a lower-level proxy computer 4 on the one hand or, on the other, a data enquiry at lead-server 7 or a higher-level proxy computer 4A.

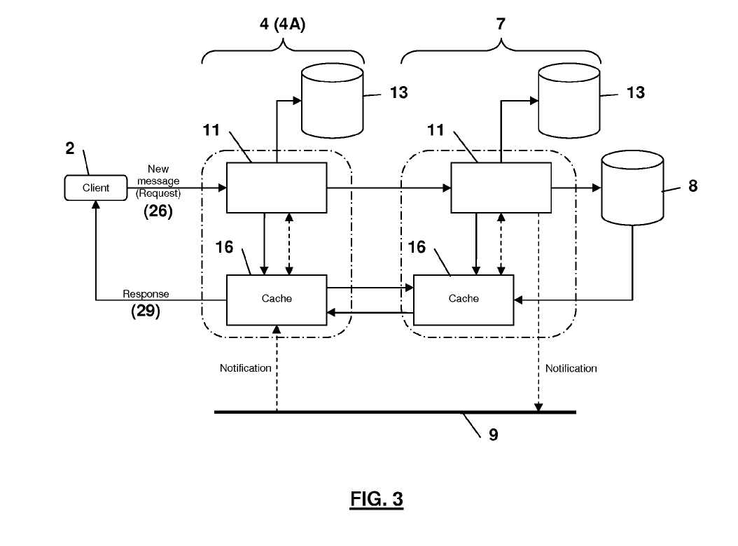

FIG. 3 schematically shows, in somewhat more detail than in FIG. 1, how a proxy computer 4 or 4A is arranged in connection with lead-server 7, whereby on the one hand, in case of proxy computer 4 or 4A, the relevance filter module 11 and the cache memory 16 are shown, which are each connected to a typical client computer 2 for receiving a new message or a polling request and for returning a response; similarly, a local data base 13 and furthermore a relevance filter module 11 and a cache memory 16 are provided for the lead-server or central controller 7. In addition FIG. 3 shows the central data base 8 assigned to lead-server 7 as well as the bus link (backbone) 9 for the notification operations shown by broken-line arrows in FIG. 1.

According to FIG. 4 the respective client computer 2 queries the associated proxy computer 4 at regular time intervals, whether a new message, for example a new offer, has arrived (see HTTP request as per arrow 20). It is assumed that in case of a buying transaction a new offer (a new bid in case of an auction) has arrived at proxy computer 4, this message having not yet been communicated to client computer 2, i.e. is not yet “visible” there. Accordingly, as depicted by the broken-line arrow 21 in FIG. 4, a corresponding notification (HTTP response) is returned to client computer 2 which means that the user of this client computer 2 has been informed of this new offer or bid. After a predetermined time interval, polling interval 22, the next HTTP request (polling request) 20 is automatically generated.

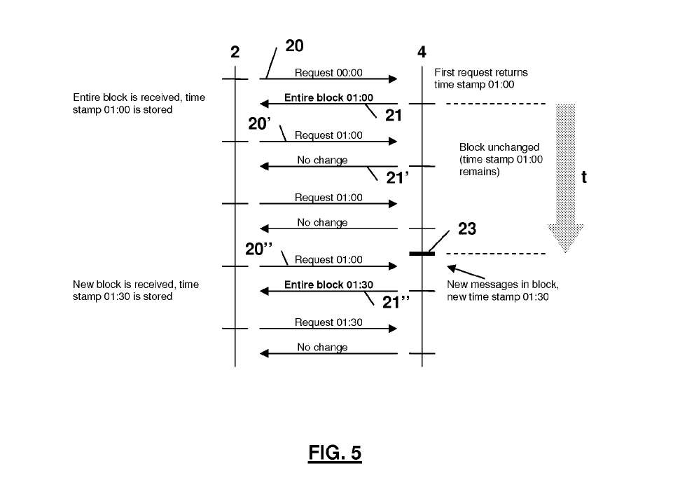

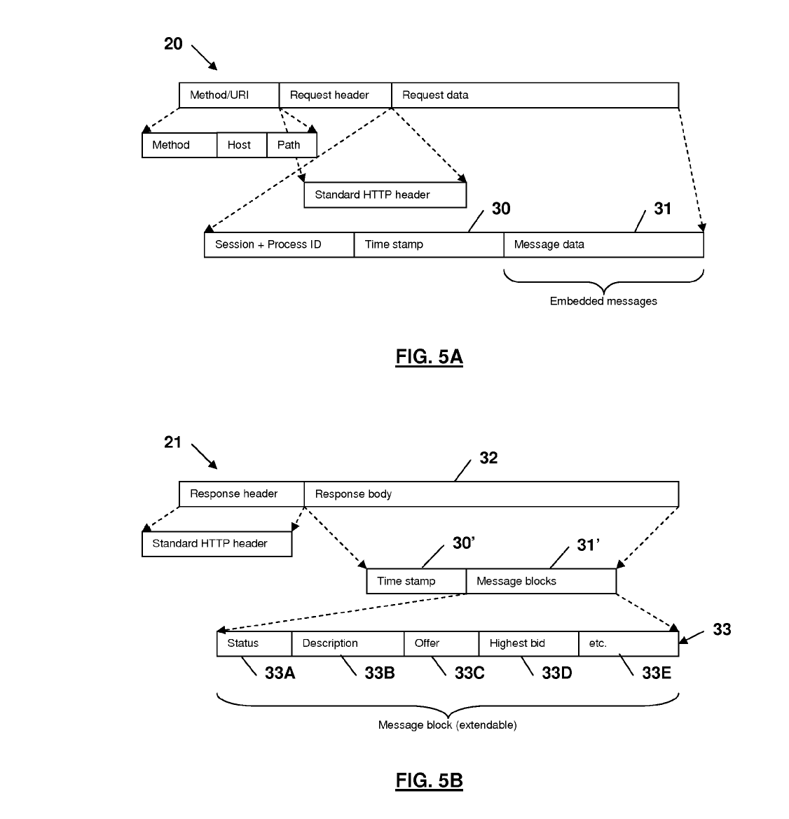

In principle this polling procedure is sufficiently known, and therefore no further explanation is necessary. Proxy computer 4, in turn, receives its information from the central lead-server 7 or from a cascaded proxy computer 4A (see FIG. 1). For bandwidth reduction or data reduction time stamps are used between client computers 2 and proxy computers 4 in the area of this link, and only amended or new messages are transferred from proxy computer 4 to client computer 2 as part of polling responses 21. This can be seen, for example, in the flow diagram in FIG. 5, where in response to the first enquiry 20 (time stamp 00:00), a message block (response 21) is returned with a time stamp of for example 01:00 from proxy computer 4 to client computer 2, where this message block is received and time stamp 01:00 is stored. The next two polling requests 20′ show that the message block is still unchanged, time stamp 01:00 remains, and response 21′ therefore indicates that there has been no change.

At a point in time 23 according to FIG. 5 a new message arrives at proxy computer 4 from a higher-level cascade proxy computer 4A or lead-server 7 which, for example, contains the new time stamp 01:30. In response to the next polling request 20″ therefore, still bearing time stamp 01:00, the whole new message block with time stamp 01:30 is returned as per arrow 21″ and stored in client computer 2 with time stamp 01:30.

In FIGS. 4 and 5 the time progression is depicted by a wide vertical arrow t.

From the above explanations it is clear that only in case of new messages available at proxy 4, these are forwarded to the associated clients 2, wherein the respective time stamp is important for the decision, whether current messages are present. This has the effect of drastically reducing the extent of the transfer of data.

New messages generated at a client computer 2 are sent to the associated proxy computer 4 by means of an “out-of-band polling request”, as shown in FIG. 6 by arrow 24. The next polling interval 22 runs from this moment in time and after receipt of this new message, arrow 24, at proxy computer 4 this message is forwarded to the next higher location, for example lead-server 7 or cascade proxy 4A, as per arrow 25. Proxy 4 however, via its relevance filter module 11 (see FIG. 2) decides whether this message, arrow 24, is forwarded to server 7 or is stored initially locally (in local data base 13), wherein in the latter case the message is not forwarded until later to server 7 for storing in central data base 8. The messages which are stored in central base data base 8 can be read out again by server 7 or any other server instances which are operated in parallel and provided for increased failure safety.

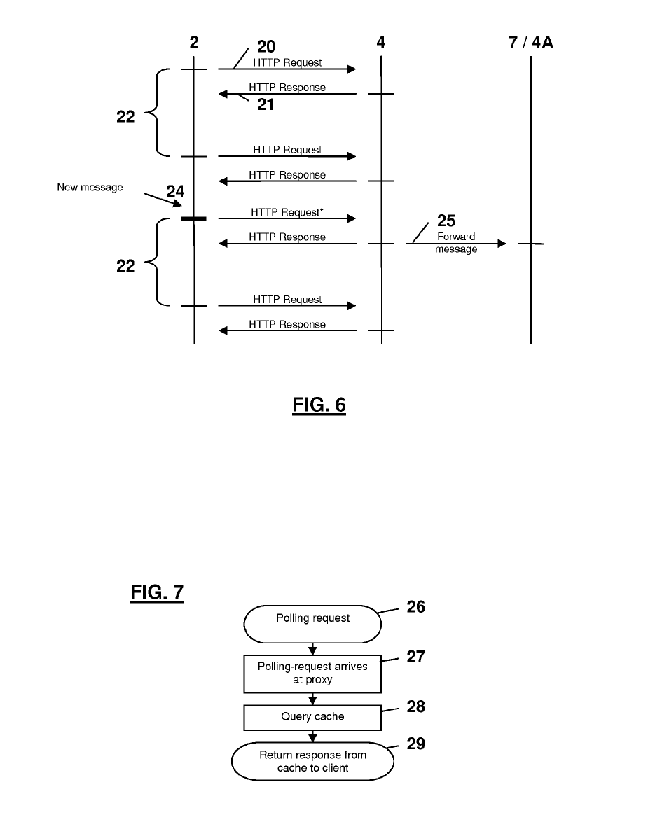

The flow diagram in FIG. 7 shows the flow of a regular polling on one of proxy computers 4. According to field 26 a polling request (20 in FIGS. 4, 5 and 6) is sent and according to block 27 this polling request arrives at proxy computer 4. Relevance filtering now takes place, see filter module 11 in FIG. 3, with a query to cache memory 16 as per block 28; according to field 29 a response is returned to client computer 2, as evident also from the illustration in FIG. 3, and where the new message or response is indicated correspondingly by reference numerals 26, 29 (in brackets).

Before going into any more detail regarding the filter procedure, further explanation is given below with respect to the data reduction procedure used in computer system 1 on the basis of time stamps assigned to all messages. These time stamps mark the last point in time for amendments to the respective message.

FIGS. 5A and 5B represent traditional HTTP polling protocols, wherein it can be seen that following introductory protocol data or header sections a time stamp 30 or 30′ is provided ahead of the actual messages 31 or 31′. The message section 32 of polling response 21 as per FIG. 5B (the so-called “response body” 32) remains completely empty if no amendments to the messages occur. As per FIG. 5B message block 31′ contains various message data 33, such as status 33A, description 33B, offer 33C, highest bid 33D and possibly other data 33E.

Client proxy query protocol 20, in case of a query, provides for the transfer of a single time stamp 30 which corresponds to the latest point in time for amendments to the transferred messages communicated to client 2. Proxy 4 stores a copy of all messages and message blocks 31′ which are queried by clients 2 connected to it in cache 16. A message block may, for example, be the list of received offers. Cache 16 is located only in working memory 15 of proxies 4, see. FIG. 2.

The cached message blocks may all be used by proxy 4 for the queries of several clients 2, if these clients 2 receive respective displays of the same information, which is usually the case in terms of trading processes: for example, all participants in the trading process see the same list of highest offers. In this way essential savings as regards working memory 15 occupied by cache 16 on a proxy 4 can be achieved.

Furthermore proxy 4 records in its cache 16 a time stamp 30 or 30′ of the respectively last amendment for each message block 31 or 31′ and for each individual message. This structure of the time stamps may be even further nested as long as the load from comparing the time stamps is lower than that from the transfer of a complete message bock.

When queries arrive from a client 2 (polling) the time stamp 30 of the incoming query is compared with the time stamps 30′ of the message blocks 31′ stored in the cache 16 of proxy 4, and if there is a deviation then the time stamps of individual messages 33 are compared. Only those messages from those message blocks are transferred to client 2 which, on the proxy 4, bear a newer time stamp 30′ than that time stamp 30 which had been sent along by client 2. Message blocks bearing older or equally old time stamps are not transferred at all and of the message blocks with younger time stamps only those messages are transferred which in turn have younger time stamps. In the ideal case an empty response is returned if all time stamps 30′ of all message blocks 33 in cache 16 are not younger than the time stamp 30 sent along by client 2.

If one proxy 4 fails it may be necessary to restore the content of cache 16 required for bandwidth optimisation on another proxy 4. Since, as a rule, only messages also transferred to server 7 are displayed on clients 2 this restoration may take place by querying the current messages on server 7. The same principle should be used even then, if the content of cache 16 is not available on the queried proxy 4 for any other reasons.

The message blocks in cache 16 may be deleted from cache 16 as soon as no client 2 any longer queries any of these message blocks. In principle this may be carried out after only a few polling intervals have passed in which the respective message block was no longer queried, since one should proceed on the basis that in each polling interval at least one of the connected clients 2 would have queried this message block.

New messages to be transferred from a client 2 to server 7 are initially transferred to a proxy 4 which then forwards them to server 7 (possibly via one or several cascaded proxies 4A). Server 7 stores the messages, as necessary, in central data base 8. These messages are thus immediately available to controller instances operated in parallel, should the first controller instance, i.e. the lead-server 7, fail.

As the messages are transferred from client 2 to proxy 4 they are embedded in a polling request 20 so that immediate results of the transferred message can be transferred to client 2 as early as in response 21 to this request.

In order to shorten the time span elapsed between creating the message on client 2 and receipt on proxy 4, messages created on a client 2 may be transferred directly to proxy 4 without waiting for the end of the polling interval. Such a request is called out-of-band request (see 24 in FIG. 6). It differs from ordinary polling requests 20 only in that the end of the normal polling interval 22 is not awaited and that, as a rule, it contains a new message for transfer from client 2 to server 7.

If at the time of initiating an out-of-band request 24 a polling request is on its way from client 2 to proxy 4, this request is aborted by client 2 by means of XMLHttpRequest.abort( ) (W3C: XMLHttpRequest, W3C working draft 20 Aug. 2009, 4.6.5 The abort( )method; http://www.w3org/TR/XMLHttpRequest/#the-abort-method); the new request is sent with the new message and the same time stamp as before.

Incoming messages are evaluated in filter modules 11 through filter algorithms which are calibrated according to the requirements of the respective trading process so that only messages relevant to the trading process are instantly transferred.

As a result of this relevance filtering the number of messages to be transferred is considerably reduced. In particular, the number of messages to be transferred does not increase with the number of participants in the trading processes but only with the number of trading processes. This is true if one works on the basis that each trading process only requires a certain maximum number of messages which is independent of the number of involved participants. In the simplest case, if the price is fixed, the first buying order suffices, all further orders are immediately irrelevant.

Messages arriving at a proxy 4 or a server 7 are, during filtering, divided into the following two categories:
messages which are directly relevant to other users (which are connected via other proxies 4 with the system 1); or
messages which are not directly relevant to other users.

The relevance of messages is assessed with respect to its importance for the trading process, which means that messages which do not have any effect upon a decision of a trading partner are graded as not directly relevant. These are, for example, offers carrying a lower price than previously arrived offers.

Instantly relevant messages are immediately transferred from a proxy 4 to server 7 (or to an intermediate cascaded proxy 4A) or from server 7 to the central data base 8.

Not instantly relevant messages are not forwarded but initially cached in a respective local data base 13. During periods when the load on computer system 1 is reduced, this data is transferred to the central data base 8 (offload data consolidation) and is thus also available for later queries in the central data base 8. This significantly relieves the load on the central data base 8.

In sending notifications proxies 4 are informed of the existence of new or amended messages on server 7. Proxies 4 therefore do not have to enquire regularly whether new or amended messages are present, but they are actively informed of this fact by server 7.

Again, notifications are sent only in the case of directly relevant messages, i.e. if these are graded as directly relevant on the basis of filtering. In this way the proxies 4 learn of the presence of new or amended messages and can retrieve these from server 7 (or from a cascaded proxy 4A). These messages are then transferred via polling to clients 2.

The notifications are, for example, sent via UDP (J. Postel, User Datagram Protocol, RFC 768, http:www.ietf.org/rfc/rfc768); if the messages are relevant to all proxies 4, then preferably via IP multicast (Network Working Group, Internet Group Management Protocol, Version 3, RFC 3376, http://www.ietf.org/rfc/rfc3376) or within a network segment via an IP broadcast (Network Working Group, Broadcasting Internet Datagrams in the Presence of Subnets, RFC 922, http://www.iet-f.org/rfc/rfc922.txt). The notifications have the effect of significantly minimising the overhead.

The notifications, in turn, can themselves transfer a simple message apart from the information that a new or amended message is present. Complex messages or whole message blocks, however, are queried with the server 7 by proxies 4.

Each server (or controller) 7 may itself fail, either because of a software or hardware error or for reasons present in the environment. Apart from conventional measures for ensuring the availability of a controller (Fail-Over Cluster, mirroring etc.) the following setup may be utilised within the computer system 1 for achieving redundant controller instances:

Since a proxy 4 cannot recognise whether the reason for no notifications arriving is because no new messages are present or because controller 7 has failed, a “heartbeat” is sent by each controller 7 in the form of UDP packets. This has the additional effect of avoiding that all proxies 4 continuously query controller 7 and thereby allow network traffic to increase. The interval depends on the time span of how quickly computer system 1 should be informed of a failure, so that corresponding alternative resources (other servers) can be activated.

As soon as a proxy 4 does no longer receive any notifications from a server 7, proxy 4 must query the latest state of existing message blocks from an alternative server, so that messages arrived and processed in the meantime are forwarded to this proxy 4 also. This alternative server then becomes the central controller instance for the trading processes concerned and, at the first query, downloads the necessary data from the central data base 8.

A proxy 4 could also fail because of a software or hardware error or for environmental reasons. Since system 1, for reasons of bandwidth optimisation, would preferably send the polling requests of a client 2 initially to always the same proxy 4, and if this proxy 4 then fails the connection of clients 2 accessing via this proxy 4 would be interrupted.

As mentioned, however, proxies 4 have load balancer modules or computers 5 arranged upstream of them, which modules evenly distribute the queries of many clients 2 among all proxies 4. If one proxy 4 fails, subsequent polling requests are forwarded by these modules to another proxy 4. Since this proxy 4 may not yet hold the queried message block ready in its working memory 15 (i.e. does not yet have it in its cache 16), proxy 4 queries the corresponding information from server 7 and puts it in its cache 16. When the information on the latest amendment of messages and message blocks is also stored on the central data bank 8 and is thus available via server 7, then it is possible, even for this restoration of the cache content on a proxy 4, to immediately transfer the exactly correct differential information to client 2 with the very first response.

Insofar as the majority of message blocks are used by many or by all clients 2, polling requests of clients 2 can even be distributed ad lib among all proxies 4 without significant bandwidth or performance losses.

In operation a respective proxy 4 or a lead-server 7 receives incoming messages from a lower-level instance, for example proxy 4 receives from client 2 or controller 7 receives from proxy 4. These messages are evaluated by the relevance filter in respect of their relevance criteria; this is done through a comparison with threshold values read from cache 16. These threshold values in turn are messages which are stored in cache 16, and may be, for example, already received bids on the same article.

Not (directly) relevant messages are cached (offloaded) in the local data base 14 and later consolidated into the central data base 8.

(Directly) relevant messages are forwarded to the next high-level instance, which for a proxy 4 is controller 7 or a cascaded proxy 4A, and for controller 7 is the central data base 8.

In addition, the local cache (cache 16) is directly informed of a relevant message which has come in. Thus lower-level instances, for example client 2, immediately receive feedback on whether a message has been forwarded or filtered out. Besides, each subsequent threshold value comparison, even before the higher-level instance (4 or 4A or 7 or 8) has (possibly) updated it, is based already on this locally updated threshold value.

Furthermore, server 7 sends a notification on the arrival of a relevant message via the notification bus 9 via which all dependent proxies 4 or 4A are informed of the presence of a new relevant message. Proxies 4, 4A thereby make their cache 16 pick up this new message from the higher-level instance (4A/7) with the next query.

Proxy 4 does not send any notifications, server 7 does not need to receive any.

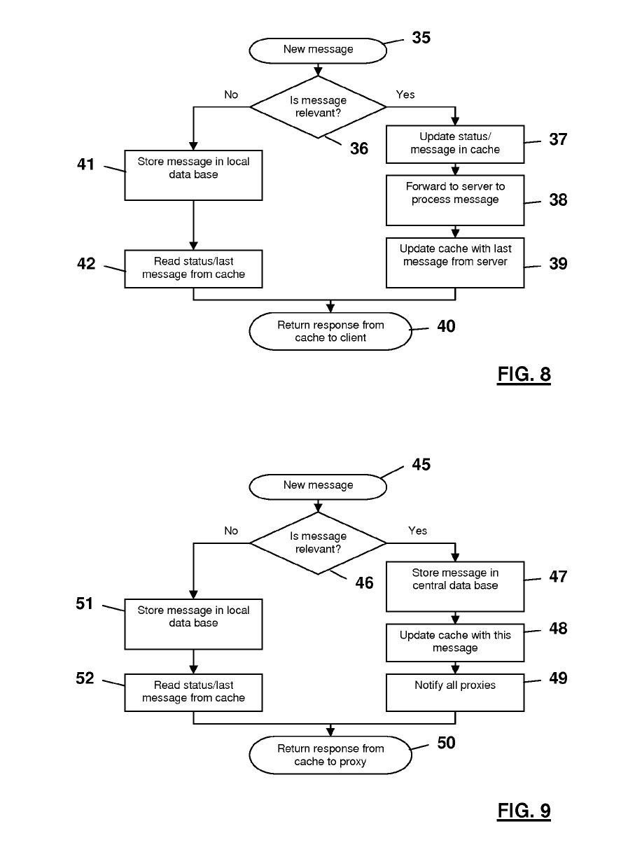

FIG. 8, a flow diagram, shows filtering on a proxy computer 4 in more detail. According to field 35 a new message is received from a client computer 2 or a preceding proxy computer 4 (if this is a cascade proxy 4A), and then a check is performed as per field 36 whether the message is relevant, i.e. whether the threshold as described has been exceeded. If yes, the status and the message are updated in the associated cache 16, see block 37, and the message is forwarded to the lead-server 7 and processed, see block 38 in FIG. 8. At block 39 cache 16 is updated with the latest message received from server 7; after that the corresponding response is returned from cache 16 to the respective client 2, see field 40.

If in field 36 the message is filtered out as not being relevant, the message is stored in the local data base 13 of proxy 4 as per block 42; according to block 42 the status or the last message is then read from cache 16 and sent as a response to client 2 according to field 40.

With the filter operation shown in FIG. 9, which takes place at lead-server 7, a new message from a proxy computer 4 or 4A is received in a corresponding manner according to field 45, and this message is checked for its relevance according to checking field 46. If the message is relevant, it is stored in the central data base 8 according to block 47, and cache 16 of lead-server 7 is updated with this message according to block 48; then according to block 49 all proxies 4 or 4A are notified which according to field 50 is carried out from cache 16 of server 7 to proxies 4 (return response).

If the message is not relevant, see checking field 46, the message is temporarily stored in the local data base 13 of server 7, see block 51 in FIG. 9, and the status or the last message is read from cache 16 of server 7, block 52, and returned in the response to proxy 4 or 4A according to field 50.

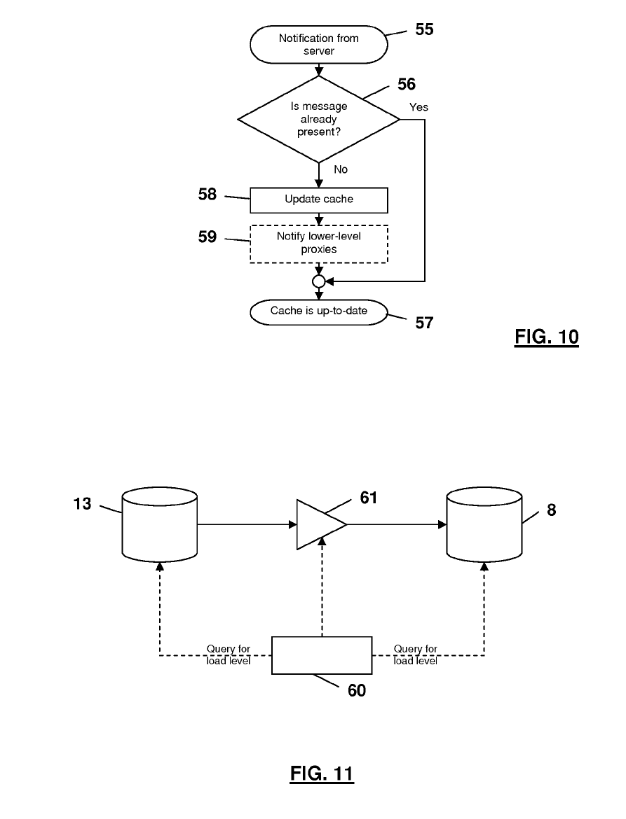

FIG. 10 is a flow diagram which shows the operation when notifying a proxy computer 4 or 4A. According to field 55 a notification takes place through the lead-server 7. A checking field 56 checks the respective proxy 4 or 4A for the presence of the message; if yes, cache 16 according to field 57 is up-to-date. If the message is not yet present, however, cache 16 is updated according to block 58. If lower-level proxies 4 are present, these are notified according to block 59 (drawn with a broken line). At the next polling the current status or the last message is returned.

The final field 57 is reached when the cache 16 has been determined to have been updated.

Consolidation of offload data bases 13 takes place at a point in time at which both the respective local data base 13 and the central data base 8 are operated significantly below full load. The load on the local and central data bases 13 and 8 is queried by means of a system load checking unit 60 (see FIG. 11) at regular intervals; if this load drops below a predetermined threshold value, the transfer of data is started, see transfer channel 61 in FIG. 11; load measuring continues during the transfer and when a threshold value is exceeded transfer is interrupted.

For consolidation the messages stored in the local data base 13, that is those messages which have not yet been forwarded to the central data base 8 at the time these messages arrived, are transferred into the central data base 8 one after the other and then, once successfully transferred, deleted from the local data base 13; this is shown in detail in the flow diagram of FIG. 12.

According to FIG. 12 a starting step 65 for consolidation is followed by a query in order to check the load on the local (offload) data bases 13 and central data base 8 according to block 66. A check is then carried out in checking field 67, whether the queried load states are below a specified threshold value, which checking takes places with checking unit 60 (which may be formed by a consolidation process). If they are, that is, if the load on system 1 is sufficiently low, the next message according to block 68 is obtained from a local data store 13 and copied into the central data base 8 as per block 69. Then a query is carried out in checking field 70 as to whether the copying operation was successful, and if yes, the message in the respective local data base 13 is deleted, see block 71; next a query is carried out in field 72, as to whether further messages are present, and if yes, the process returns to block 66 in the flow diagram of FIG. 12. If no further messages are present in the respective local data base 13 the process goes to field 73 and the consolidation process is finished.

This also happens if the query as per field 67 shows that the load states are above the threshold value; nevertheless the consolidation process is terminated, at least temporarily, see field 73.

If according to query field 70 copying of the message into the central data base 8 was not successful, the error is recorded according to block 74, and a note is made to restart consolidation once more at a later time. After that consolidation 73 is again terminated.

Thus, as evident, consolidation can be interrupted at any time when the load on the local data base 13 or on the central data base 8 increases due to ongoing trading processes, and can be resumed at a later stage.

In order to avoid duplication of messages all messages are identified by a UUID (Network Working Group: A Universally Unique Identifier (UUID), URN Namespace RFC 4122, http://www.i-etf.org/rfc/rfc4122.txt).

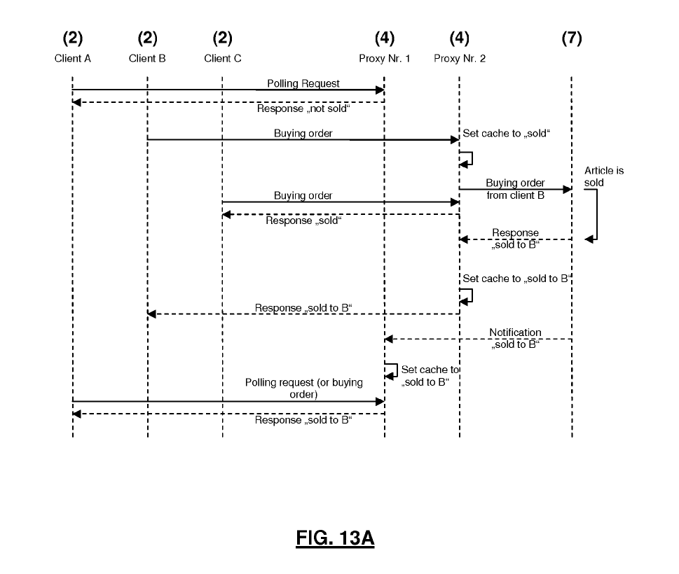

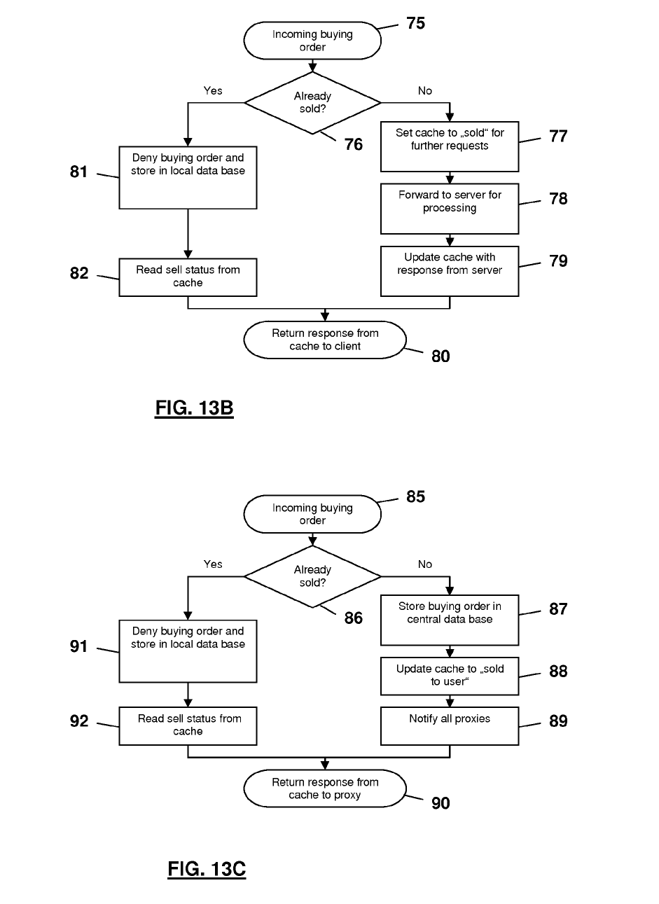

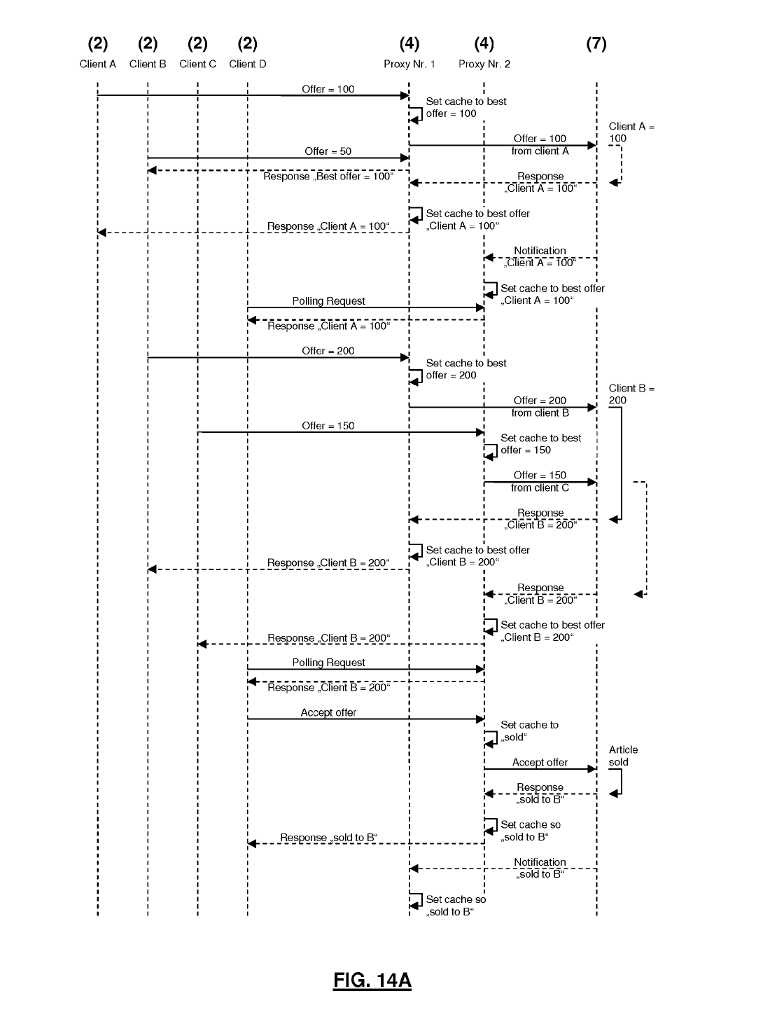

Finally, the operation of the present computer system 1 shall be additionally explained by way of various typical applications with reference to FIGS. 13 to 17.

FIGS. 13A to 13C refer to the operation of an immediate sale of individual articles.

Individual articles can be sold immediately at the price indicated; the sale is completed immediately at the first buying order, all other interested buyers can track the sale live. Both buyers and sellers can track the sale of an article in real time.

Only the first buying order for an article arriving at a proxy 4 is forwarded, all others are immediately rejected on the basis of relevance filtering and are merely stored in the local data bases 13 of the respective proxy 4. As the first buying order arrives at a proxy 4, the article is deemed to have been sold, only the lead-server 7 still has to query to which buyer the article was sold: i.e. that buyer whose buying order arrived first at this or another proxy 4.

The first buying order arriving at server 7 results in the sale of the article and is stored in the central data base 8, the server 7 immediately notifies all proxies 4 of the completed sale. All other buying orders are immediately rejected and are merely stored in the local data bases 13.

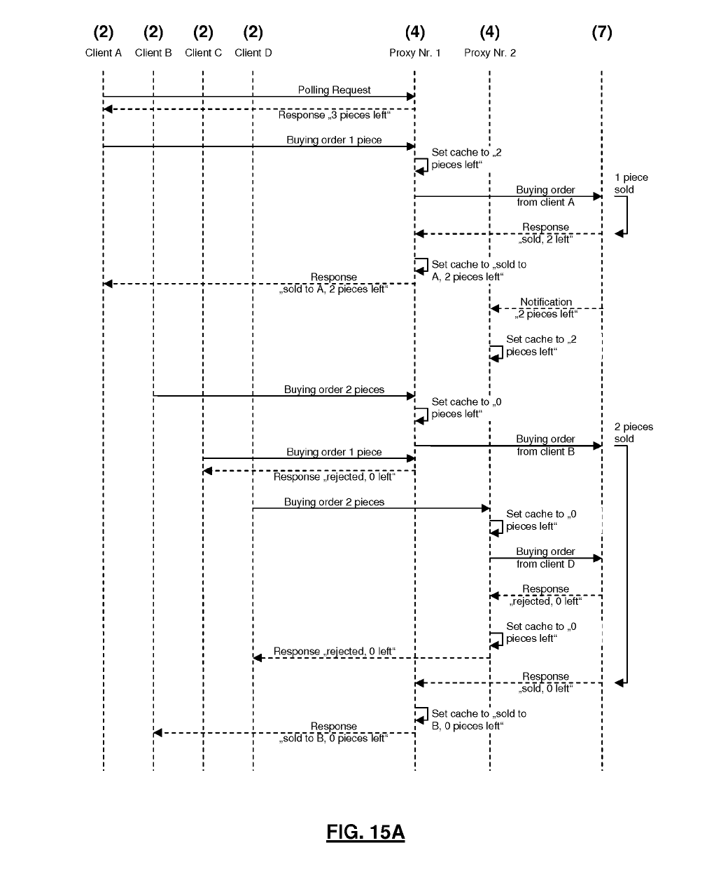

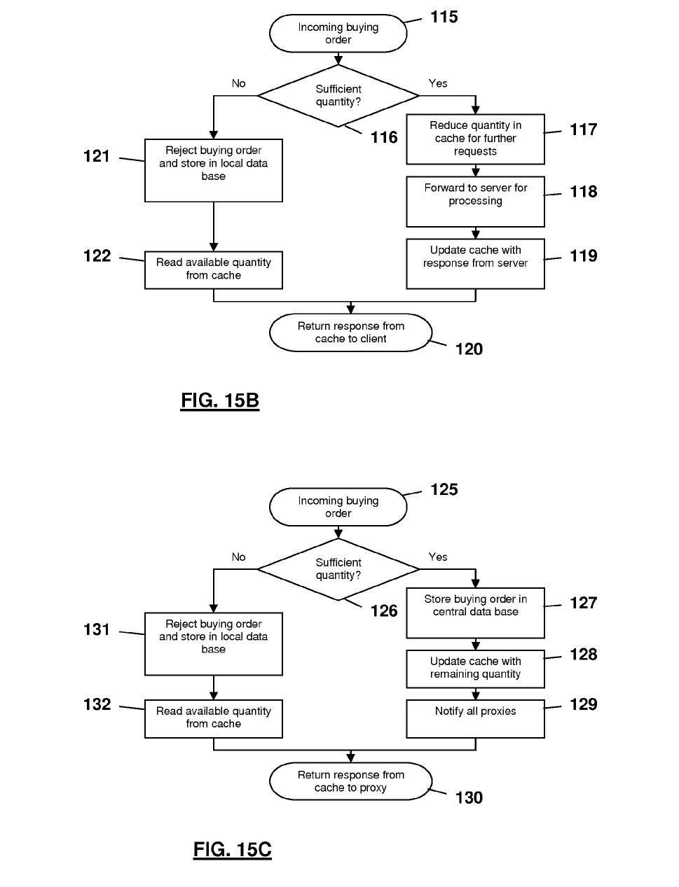

The number of buying orders per article sent to server 7 equals at most the number of proxies 4 connected with this server 7. For example, as shown in FIG. 15A, client A is connected with proxy no. 1; clients B and C are connected with proxy no. 2. Clients B and C attempt shortly one after the other to buy an article by sending a buying order. Client A only observes the operation. The first one who has sent the offer obtains the article, in this case client B. the buying order from client C is immediately rejected and not forwarded to server 7, since a buying order had already been received on the same proxy 4 from client B.

This process is illustrated in the sequence diagram of FIG. 13A.

FIG. 13B shows the associated filter operation on a respective proxy computer 4 in a flow diagram. Field 75 represents an incoming buying order and field 76 then checks whether the article has already been sold to some other user. If not, as shown in block 77, the associated cache 16 of the respective proxy computer 4 is set to “sold” for any further requests, and as shown in block 78 a corresponding message is forwarded to lead-server 7 and processed there; according to block 79 cache 16 is then updated with the response from lead-server 7, and according to block 80 the corresponding response is returned from cache 16 to the respective client 2, for example client B.

If during the query as per field 76 it is found that the article has already been sold, which is the case in the example of FIG. 15A for client C, the buying order (from proxy no. 2) is immediately rejected (block 81) and stored in the local data base 13 of this proxy computer 4 (that is, in the example shown in FIG. 13A, proxy no. 2). According to block 82 the sale status is now read from cache 16 and returned in the response to client (here client C) (response is “sold”), see field 80 in FIG. 13B.

With the filter operation taking place at lead-server 7 according to flow diagram shown in FIG. 13C, the buying order from one of proxy computers 4, here proxy no. 2, is received as per field 85, whereupon as per checking field 86 a check is carried out whether the article has already been sold. If not, the buying order is stored in the central data base 8 as per block 87; cache 16 of lead-server 7 is updated as per block 88 (“sold to user—client-B”); thereafter all proxies 4 are notified accordingly, see block 89, and the respective response is returned from cache 16 to the respective proxy (here proxy no. 1), see field 90 in FIG. 13C.

If, on the other hand, the query as per field 86 finds that the article has already been sold, the buying order just received as per block 91 is rejected and stored in the local data base 13 of lead-server 7. According to block 92 the sale status is then read from cache 16 and returned in the response from cache 16 to the corresponding proxy 4 (field 90).

A further example of an implementation is the so-called live online trade, whereby offers may be made on articles; it is up to the seller to decide when to accept the offer—the best offer. With this scenario it is always a respectively higher offer (i.e. higher than all previously received offers) on an article received at a proxy 4 which is forwarded to the lead-server 7. All other offers are immediately rejected and stored in the local data base 13 of the respective proxy 4.

The lead-server 7 also stores only a respectively better offer directly in the central data base 8, and all proxies 4 are immediately notified of this received offer. All other offers are immediately rejected and only stored in the local data base 13.

The seller can accept the highest offer; this offer acceptance is initially received by a proxy 4, which forwards it immediately to server 7.

After receiving the offer acceptance on server 7 it is immediately stored in the central data base 8, and all proxies 4 are notified of the sale.

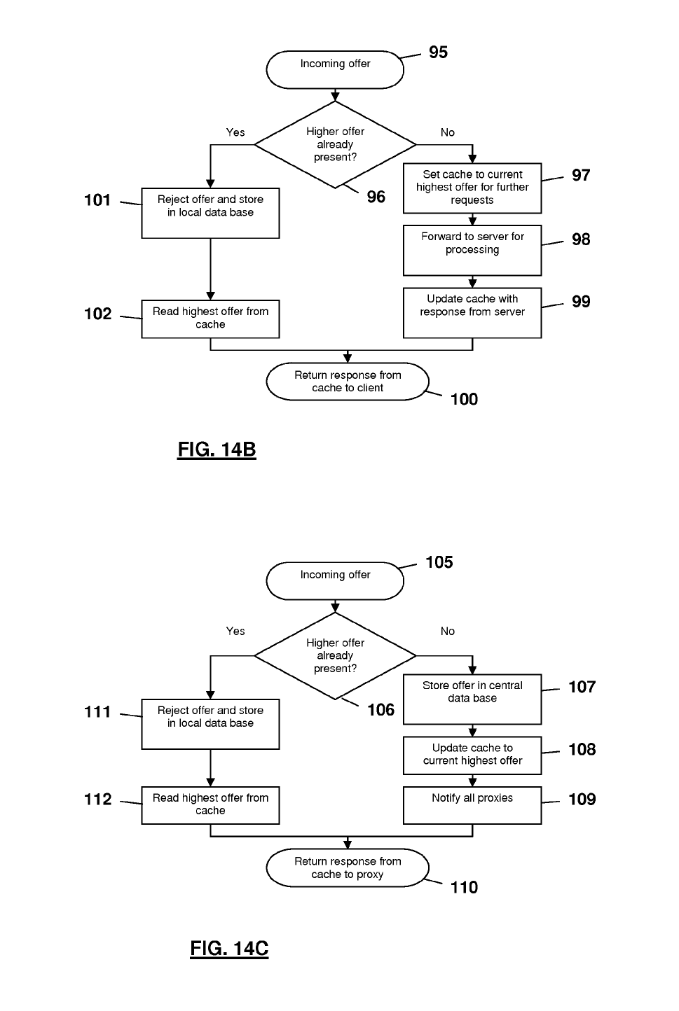

For example, as shown in FIG. 14A, client A and B (both buyers) are linked to proxy no. 1, client C (buyer) and client D (seller) are linked to proxy no. 2. Clients A and B send offers shortly one after the other, proxy no. 1 immediately forwards only the higher offer to client A and the offer from client B is immediately rejected. Client B then sends an even higher offer and client C sends a lower one than client B. The offer from client B is forwarded; the offer from client C, because it was received on another proxy 4, i.e. proxy no. 2, is not rejected until it has reached server 7.

In the example according to FIG. 14A which is quite self-explanatory the first offer from client A was 100, the offer received thereafter from client B was 50; this offer from client B was, however, subsequently increased to 200; the offer then sent from client C of 150 was therefore below this previous offer of 200 and was therefore not successful. Subsequently the seller, i.e. client D, decides not to wait any further for more offers and accepts the offer of 200 from client B, so that the article was sold to B.

Further details in connection with this typical process are evident directly from FIG. 14A.

FIG. 14B, in a flow diagram, shows the general filter operation on one of the proxies (proxy no. 1 or proxy no. 2 as per FIG. 14A). An offer received as per field 95 is checked as per checking field 96 to find out, whether cache 16 of this proxy holds a higher offer or not. If not, cache 16, as per block 97, is set to the current highest offer for further requests, and the offer is forwarded to lead-server 7 and processed there, see also block 98; subsequently cache 16 is updated according to the response from server 7 as per block 99, and according to field 100 a response is returned from cache 16 to respective client 2.

If, however, the check as per field 96 shows that a higher offer already exists, the offer concerned is rejected as per block 101 and stored in the local data base 13; according to block 102 the highest offer is read from cache 16 and returned in the response to the respective client 2, see field 100.

During filtering on lead-server 7 according to the flow diagram in FIG. 14C an offer received from a proxy 4, see field 105, is checked according to checking field 106 to find out whether a higher offer exists. If this is not the case the received offer is stored as per block 107 in the central data base 8, and cache 16 of server 7 is set to the current highest offer, see block 108. Then all proxies 4 are notified as per block 109 of this offer determined as being the highest offer, and a corresponding response is returned from cache 16 to proxies 4, see field 110.

If, however, a higher offer was already present (see checking 106), the received offer is rejected as per block 111 and stored in the local data base 13 of lead-server 7. Further, according to block 112, the existing highest offer is read from cache 16, and a corresponding response is returned from cache 16 to proxies 4, see field 110.

The next example which will now be explained by way of FIGS. 15A to 15C refers to the online sale of article quantities (so-called “teleshopping channel”). In detail, a certain quantity of equivalent articles on offer is sold in sequence or in parallel. Each buying order coming in is automatically accepted until all articles have been sold. Also several articles (for example 2-off) may be sold with one buying order.

Each buying order for an article on offer received from a proxy 4 is forwarded as long as the currently known number of items of the article on offer which is to be sold is not exhausted. All other buying orders are immediately rejected and only stored in the local data base 13 of the respective proxy 4. Each individual sale must, however, be confirmed by server 7 since it is possible that items of the same article on offer are in demand on other proxies 4 at the same time.

Buying orders received on server 7 result in the sale of the article quantity until the available quantity of this article on offer has been reached. Server 7 immediately notifies all proxies 4 of each completed sale and of the remaining available quantity (number of items) of the article on offer. All further buying orders are immediately rejected and stored only in the local data base 13 of server 7.

The number of buying orders per article sent to server 7 is limited by the number of proxies 4 multiplied by the quantity of the respective article on offer.

In the concrete example shown in FIG. 15A clients A, B and C are linked to proxy no. 1, client D is linked to proxy no. 2. A quantity of 3 is available for the article on offer. A buys 1-off, and then B buys 2-off. The buying orders from C and D immediately following that from B are rejected. The buying order from client C is rejected immediately by proxy no. 1 (not forwarded to controller 7), that from client D is not rejected until it has reached controller 7, because the notification that the number of items had been exhausted had not yet been received on proxy no. 2.

The process described briefly above is illustrated in FIG. 15A so that no further explanation is needed.

FIGS. 15B and 15C again show the filter operations on a proxy on the one hand (FIG. 15B), and on the lead-server 7 (FIG. 15C) on the other, in the form of flow diagrams.

According to FIG. 15B a buying order is received at a proxy (for example proxy no. 1) (field 115), and a check is carried as per field 116 whether according to this proxy 4 a sufficient quantity of the article is available. If yes, the quantity in cache 16 (block 116) of this proxy 4 is reduced with respect to further requests and the buying order is forwarded (block 118) to server 7 and further processed in there. According to block 119 cache 16 is then updated with the response from server 7, and a corresponding response is returned from cache 16 to client 2 who is buying the article, see field 120.

This type of procedure takes place for the first two buying orders, i.e. client A and client B according to FIG. 15A.

If, however, checking field 116 finds that the quantity available is not sufficient (see also the order for buying 1-off from client C or the order for buying 2-off from client D) then according to block 121 in FIG. 15B the buying order from the associated proxy (proxy no. 1 in the first case and proxy no. 2 in the second case) is rejected and stored in the associated local data base 13. According to block 122 the quantity still available is read from cache 16. Thereafter a corresponding response is again sent from cache 16 to the respective client 2, according (field 120).

As regards server 7, see FIG. 15C, a check is again performed following receipt of a buying order from a proxy 4 (field 125 in FIG. 15C), whether the quantity is sufficient, and if yes, the respective buying order is stored in the central data base 8 (block 127). Cache 16 of server 7 is updated to reflect the new quantity (block 128) and all proxies (proxies no. 1 and no. 2 in FIG. 15A) are notified accordingly (block 129); a corresponding response is returned from cache 16 to the proxies 4 (field 130).

If, however, the quantity available for the article is no longer sufficient (checking field 126), the buying order is rejected (block 131) and stored in the local data base 13 of server 7. According to block 132 the remaining quantity available (possibly a quantity of 0) is read from cache 16 of server 7, and a corresponding response is returned from cache 16 to proxies 4, see field 130 in FIG. 15C.

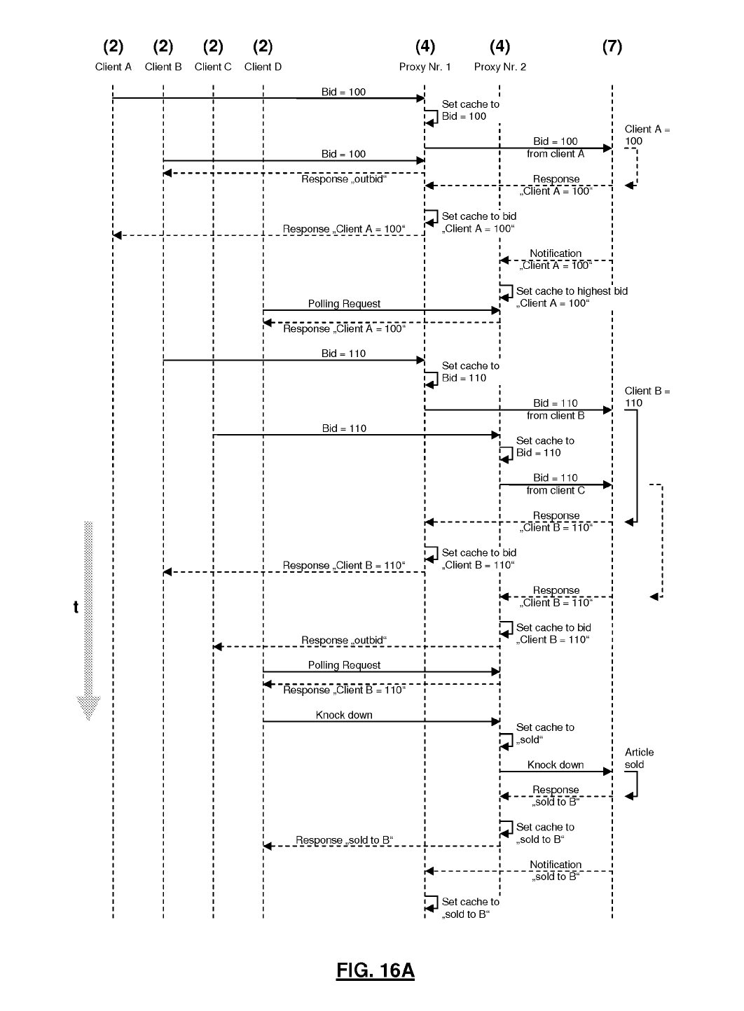

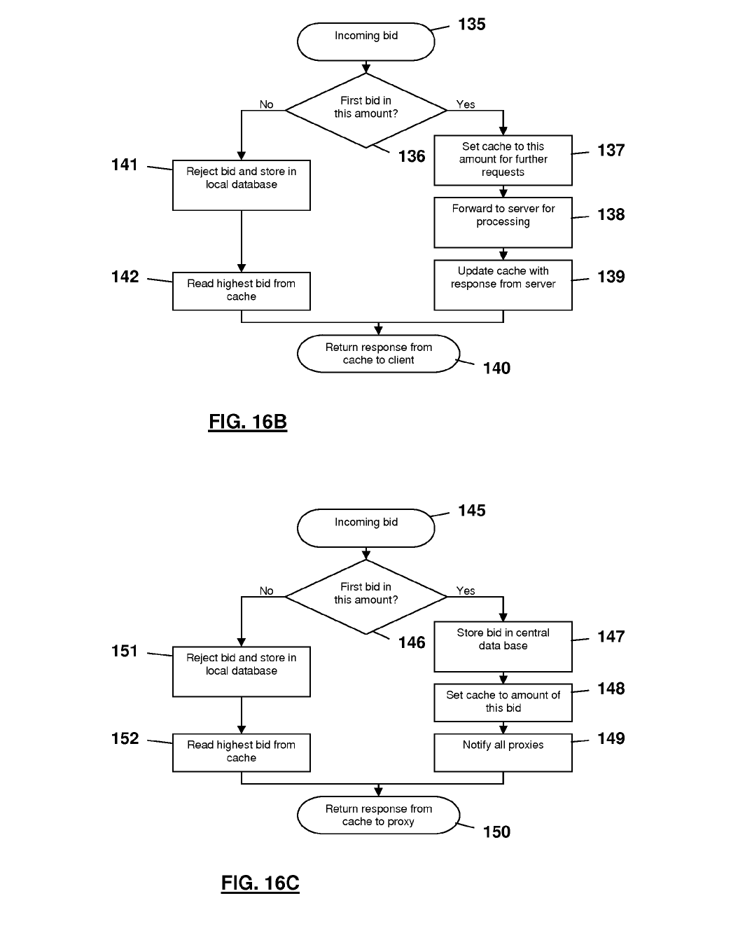

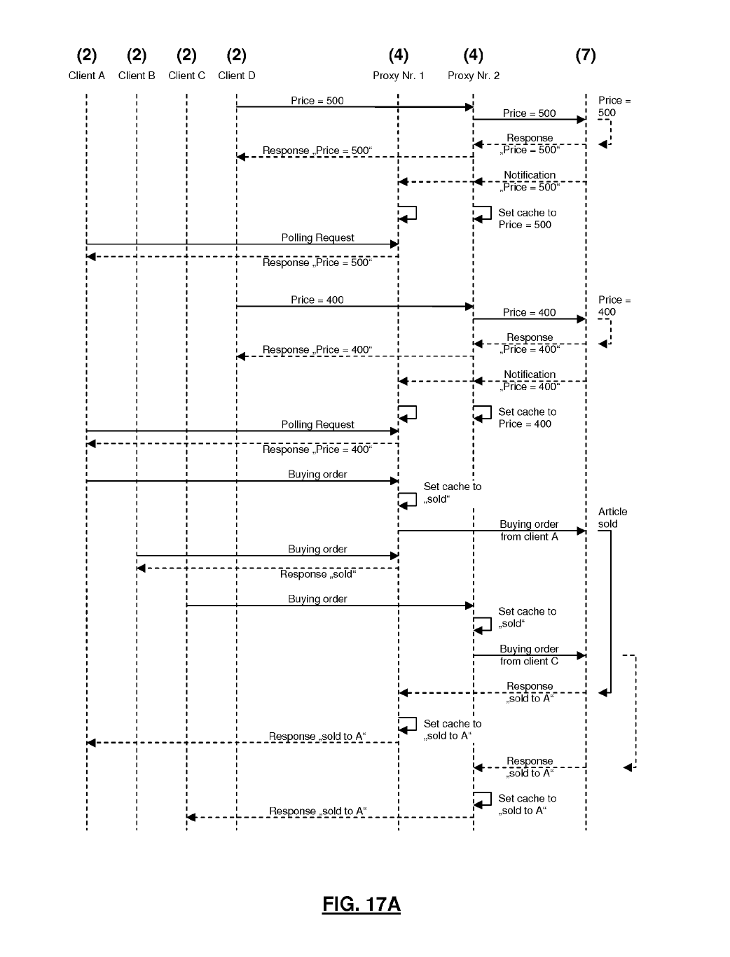

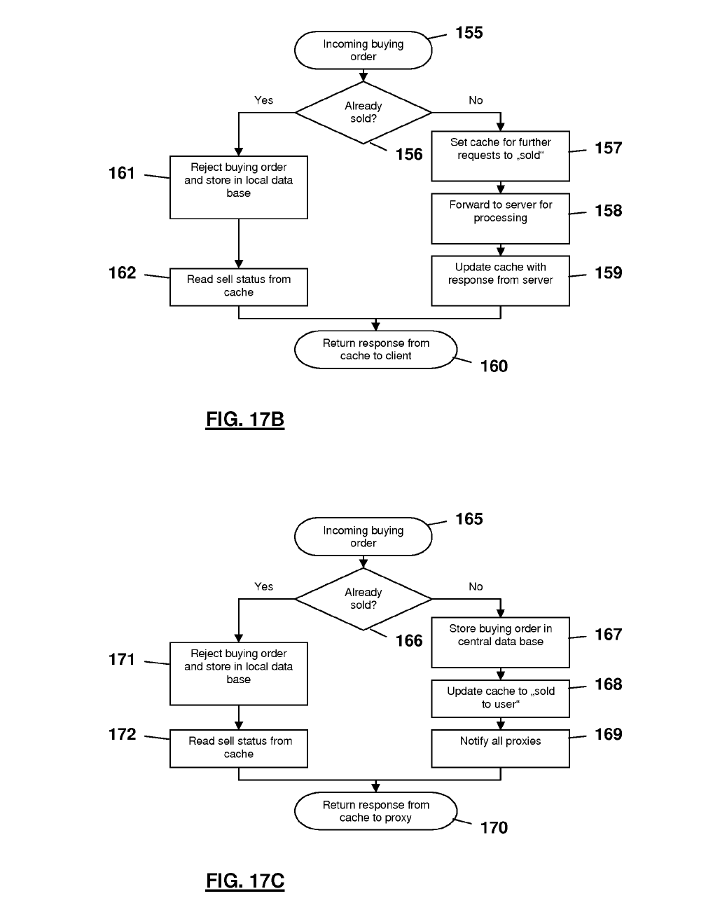

The last two examples shown in FIG. 16 and FIG. 17 refer to various bidding methods or auctions which can be carried out over the present computer system 1 also in real time and online, including for a very large number of participants.

In detail FIGS. 16A, 16B and 16C show the procedure followed with an “English” bidding method, where the bidders in the auction bid live for an article; the auctioneer respectively accepts the first bid which is higher than the preceding bid. If within a certain amount of time no higher bids are received, acceptance follows.

Only the first bid in the amount of the next bidding step (proposed by the auctioneer) received at a proxy 4 is forwarded to server 7, respectively. All other bids are immediately rejected and stored in the local data base 13 of the respective proxy 4.

Server 7 also takes only the first bid in the amount of the next bidding step into account, stores it immediately in the central data base 8 and immediately notifies all proxies 4 of this bid. All other bids are immediately rejected and stored only in the local data base 13.

The auctioneer waits for a certain amount of time before accepting the article at the highest bid received.

This bid is also forwarded via a proxy 4 to server 7, which stores the acceptance and notifies all other proxies 4 of the acceptance.

For example, according to FIG. 16A, clients A and B (buyers) are linked to proxy no. 1, client C (buyer) and client D (auctioneer) are linked to proxy no. 2. Clients A and B both bid in short succession at the same bid step, then B and C bid. The first bid from client B can be immediately rejected by proxy no. 1 without forwarding it to controller 7, the bid from client C is not rejected until it has reached server 7, since this bid had arrived at proxy no. 2 which, however, had not yet been notified from the earlier arrival of the bid from client A (at proxy no. 1). The auctioneer, client D, only ever sees the respective highest bid and accepts this at the given time.

The actual process with this English bidding method, where initially two identical bids from A and B are received one after the other and then again identical increased bids from B and C are received one after the other at the respective proxies, wherein the increased bid from client B is finally accepted, is illustrated in detail in the sequence diagram of FIG. 16A, making a detailed description superfluous.

Nevertheless the flow diagrams shown in FIGS. 16B and 16C shall also be explained in detail in conjunction with the filter operations at the respective proxy 4 or at the server 7.

In FIG. 16B, again, the filter operation on a proxy 4 is illustrated in a flow diagram. According to field 135 a bid is received at proxy 4 (for example proxy no. 1 in FIG. 16A), followed by a query as part of the relevance check as per checking field 136, whether this is a first bid in this amount, wherein as explained above with reference to FIG. 2, a comparison is carried out with the content of cache 16 of this proxy 4. In case it is indeed a first bid in the given amount, cache 16 of proxy 4 is set to this bid amount for further requests (block 137), and the bid is forwarded (block 138) to lead-server 7 and processed in there. According to block 139 cache 16 is then updated with the response from lead-server 7 (see the line in FIG. 16A “set cache to bid from client A=100”) and a corresponding response is returned from cache 16 to the respective client, for example client A as per FIG. 16A (field 140).

In case a better bid has arrived before which is ascertained as per checking field 136, the bid is rejected (block 141) and stored in the local data base 13 of respective proxy 4. According to block 142 the highest bid is read from cache 16, and according to field 140 a response is returned from cache 16 to respective client 2, such as the response “already outbid” in FIG. 16A.

With regard to server 7 which again then performs the relevance check, if bids arrive via different proxies 4, a bid arriving as per field 145, which comes from a proxy 4, is checked as per checking field 146, as to whether this is a first bid in this amount. If yes, this bid is stored in the central data base 8, see block 147 and cache 16 is set to this bid (block 148), and all proxies 4 are notified accordingly (block 149), see for example notification “client A=100” to proxy no. 2 in FIG. 16A. Field 150 in FIG. 16C also represents the return of the response from cache 16 to the respective proxy 4. Similarly to the case in FIG. 16B, if a better bid arrives (see checking field 146), the bid as per block 151 in FIG. 16C is rejected and stored in the associated data base; then the highest bid is read from cache 16 (block 152) and a corresponding response is sent from cache 16 to the respective proxy (field 150).

Finally, the process of the so-called “Dutch bidding method” shall be explained with reference to FIG. 17, wherein here the price for a certain article is continuously reduced until the first buying order at the proposed price arrives.

Only the very first buying order arriving at a proxy 4 at the price continuously lowered by the auctioneer is forwarded to server 7. All others are immediately rejected and stored in the local data base 13 of the proxy.

The server 7 also only stores the very first buying order in data base 8 and immediately notifies all proxies 4 of the sale gone through. All other buying orders are immediately rejected and only stored in the local data base 13.

As the auctioneer fixes a lowered price, this is initially also sent to a proxy 4 and then to a server 7. This is done without immediately updating cache 16 on proxy 4—the proxies 4 only learn of the new price through the notification from server 7, in order to ensure that all proxies 4 learn of this at more or less the same time.

The number of buying orders per article which are sent to server 7 is limited by the number of proxies 4.

In the example as per FIG. 17A clients A and B (buyers) are linked to proxy no. 1, client C (buyer) and client D (auctioneer) are linked to proxy no. 2. Initially client D (auctioneer) lowers the price from 500 to 400, then all buyers send their buying orders shortly one of the other, the buying order from client A—as the first at this price —completes successfully. The buying order from client B may be rejected immediately by proxy no. 1, that from client C by server 7 when it arrives there, since the notification on the successful sale has not yet arrived at proxy no. 2.

Again the sequence diagram as per FIG. 17A, similarly to the diagrams as per FIG. 16A, 15A or 14A, is self-explanatory so that no further explanation is necessary.

FIG. 17B, in a flow diagram, again illustrates the process of a filter operation on a proxy, i.e. for a relevance check, wherein according to field 155 a buying order arriving from a client 2 checks the relevance (relevance checking field 156) i.e. it queries whether the object concerned has already been sold. If not, the respective cache 16 is set to “sold” for further requests from associated clients (block 157), the buying order is forwarded to and processed in, lead-server 7 (block 158), and cache 16 is updated with the response (block 159) which arrives from lead-server 7.

According to field 160 the corresponding response is then returned from cache 16 to client 2.

If according to the check, field 156, the article proves to have been sold, the buying order of respective client 2 is rejected as per block 161 and stored in the local data base 13 of the respective proxy 4. According to block 162 the sale status is read from cache 16 and a corresponding response is returned from cache 16 to client 2, see field 160.

As regards the relevance check (filtering) on lead-server 7 which is illustrated in a flow diagram in FIG. 17C, the buying order arriving as per field 165 at a respective proxy 4 is checked as per checking field 166 as to whether the article has already been sold. If not, the buying order is stored in the central data base 8, see block 167 and cache 16 is updated as per block 168 (entry: “sold to user”). Thereafter all proxies 4 are notified as per block 169, that is proxies no. 1 and 2 in the simplified illustration as per FIG. 17A; a corresponding response is returned from cache 16 to proxies 4, see field 170 in FIG. 17C.

If, however, the respective article has already been sold (see checking field 166), the buying order is rejected as per block 171 and stored in the local data base 13. According to block 172 the sale status is read from cache 16 and according to field 170 a response is returned from cache 16 to proxy 4.

The above description reveals that the present computer system 1, through task-specific division, load distribution and filtering, permits online processing of trading processes generally in real time, wherein special relevance filtering in proxy computers 4 constitutes a particular aspect, since it allows many queries or orders to be stopped as early as at this intermediate location and only really relevant requests to be forwarded to the lead-server 7. Using the time-stamp process described an additional reduction of bandwidth or a reduction of necessary data transfers is achieved, since only differential data, i.e. data carrying a younger (later) time stamp are accepted as relevant data or messages.

Although the invention has been explained in detail with reference to especially preferred embodiments, variations and modifications are, of course, nevertheless feasible without deviating from the scope of the invention. For example, it is feasible to provide a computer system 1 without a cascading 4′ of proxy computers 4, 4A. Also a single load balancer computer module 5 may be used for all proxies 4, in order to achieve the corresponding load distribution.

1. A computer system (1) for the exchange of messages via internet for the online processing of trade transactions, comprising a plurality of client computers (2) with internet interfaces (3), at least one central lead-server (7) connected to a central data base (8), and a plurality of proxy computers (4, 4A) provided to act as distribution points between the client computers (2) and the at least one central lead-server (7), wherein the proxy computers (4, 4A) have at least one load balancer module (5) adapted to distribute messages among predefined proxy computers (4) arranged upstream of them, and each proxy computer (4, 4A) and the at least one lead-server (7) comprise a relevance filter module (11) which is adapted to check arriving messages coming in from client computers (2) for their relevance according to redefined criteria wherein in the case of a proxy computer (4, 4A) the associated relevance filter module (11) is adapted to correspondingly update a cache (16) connected to the filter module (11) in the case of relevant messages, and to forward only relevant messages upstream to an upstream proxy computer (4A), if any, or to the at least one central lead-server (7), and wherein the relevance filter module (11) of the lead-server (7) is adapted to update an associated cache (16) in the case of relevant messages, and to notify all proxy computers (4, 4A) of received relevant messages downstream, wherein the communication between client computers (2) and proxy computers (4) is based on the HTTP protocol.

2. Computer system according to claim 1, wherein at least one proxy computer (4A) is arranged in cascade with upstream proxy computers (4).

3. Computer system according to claim 2, wherein the cascade proxy computer (4A) also comprises a relevance filter module (11) which forwards relevant messages arriving from the upstream proxy computers (4).

4. Computer system according to claim 1, wherein the central lead-server (7) also comprises a relevance filter module (11) which acquires relevant messages arriving from proxy computers (4) for further processing.

5. Computer system according to claim 4, wherein further the central lead-server (7) has a local data base (13) assigned to it for at least temporarily storing messages which are recognised as not being relevant.

6. Computer system according to claim 1, wherein at least one of the proxy computers (4) has a local data base (13) assigned to it for at least temporarily storing messages which are recognised as not being relevant.

7. Computer system according to claim 5, wherein a system load checking unit (60) is provided, which is configured to arrange, at times of reduced load in the computer system, for the transfer of non-relevant messages stored in the local data base or date bases (13) to the central data base (8) for data consolidation.

8. Computer system according to claim 1, wherein the client computers (2) are adapted to cyclically request messages destined for them from the associated proxy computers (4) at predefined polling intervals.

9. Computer system according to claim 1, wherein the client-computers (2) are adapted to transfer messages to the respective proxy computers (4) immediately, outside predefined polling intervals.

10. Computer system according to claim 1, wherein client (2) and proxy computers (4) are adapted to provide the messages transferred between them with time stamps (30; 30′) and the proxy computers (4) are adapted to always dispatch only messages with a time stamp younger than that of the client computer (2) to the client computer (2).
